(19) United States
(12) Patent Application Publication
(10) Pub. No.: US 2007/0207650 A1
(43) Pub. Date: Sep. 6, 2007

(54) Card connector having an ejecting member with which a cam follower and a locking member are integrally coupled

(76) Inventors: Chikara Saito, Tokyo (JP); Joe Motojima, Tokyo (JP)

Correspondence Address: WILLIAM COLLARD;COLLARD & ROE, P.C., 1077 NORTHERN BOULEVARD, ROSLYN, NY, 11576, US

(21) Appl. No.: 11/606,218

(22) Filed: Nov. 29, 2006

(30) Foreign Application Priority Data
Nov. 30, 2005 (JP) 2005-346910

(51) Int. Cl. H01R 13/62

(52) U.S. Cl. 439/159

(57) ABSTRACT

For connecting a card, a card connector includes a connector body for receiving the card and an ejecting mechanism adapted to eject the card. The ejecting mechanism includes an ejecting member to be moved together with the card and a cam coupled to the connector body for controlling movement of the ejecting member. The ejecting member includes an ejecting member body guided by the connector body, a cam follower connected to the ejecting member body and guided by the cam, and a locking portion connected to the ejecting member body and displaceable between a first position where movement of the card is locked and a second position where movement of the card is unlocked. The connector body has a receiving portion for maintaining the locking portion at the first position where the ejecting member is located at a specific position.

This application claims priority to prior Japanese patent application JP 2005-346910, the disclosure of which is incorporated herein by reference.

### BACKGROUND OF THE INVENTION

This invention relates to card connector for use in connecting a card and, in particular, to a push-push type card connector capable of inserting a card into the connector and ejecting the card from the connector by repeating a pushing operation.

Japanese Patent (JP-B) No. 3407194 discloses a card connector of the type. The card connector comprises an insulator, a plurality of contacts, a movable plate mounted to the insulator, and a coil spring continuously urging the movable plate in a card ejecting direction. The movable plate has an elastic guide pin. The guide pin has an end portion which serves as a cam follower guided by a cam mechanism formed on the insulator. When a card is inserted into the connector, a forward end of the card is brought into contact with a card contacting portion of the movable plate. When the card is further inserted inward, the movable plate is moved and locked by the cam mechanism. Simultaneously, a plurality of pads formed on the card are electrically contacted with the contacts. When the card is again pushed inward in the connector, the movable plate is moved in the ejecting direction by an urging force of the coil spring to eject the card from the connector. Thus, the movable plate serves as an ejecting member.

However, the above-mentioned card connector does not have means for preventing the card from jumping out. Therefore, the card may unintentionally be jumped out from the connector.

Japanese Patent (JP-B) No. 3248068 discloses another card connector of the type. The card connector has a slider which serves as an ejecting member. The slider is provided with a locking portion which comprises a spring member as a separate component having a protrusion for preventing the card from jumping out.

However, the spring member is a separate component separate from the slider so that the number of components is increased.

### SUMMARY OF THE INVENTION

It is therefore an object of this invention to provide a card connector which is reduced in number of components by integrally coupling a cam follower and a locking portion with an ejecting member.

It is another object of this invention to provide a card connector capable of preventing displacement of a locking portion to lock a card to prevent release of the card after the card is connected.

It is still another object of this invention to provide a card connector in which a locking portion is given a card insertion error preventing function.

Other objects of the present invention will become clear as the description proceeds.

According to an aspect of the present invention, there is provided a card connector for connecting a card, the card connector comprising a connector body for receiving the card and an ejecting mechanism coupled to the connector body and adapted to eject the card, the ejecting mechanism comprising an ejecting member to be moved together with the card and a cam coupled to the connector body for controlling movement of the ejecting member, the ejecting member comprising an ejecting member body guided by the connector body, a cam follower connected to the ejecting member body and guided by the cam, and a locking portion connected to the ejecting member body and displaceable between a first position where movement of the card is locked and a second position where movement of the card is unlocked, the connector body having a receiving portion for maintaining the locking portion at the first position where the ejecting member is located at a specific position.

### BRIEF DESCRIPTION OF THE DRAWING

FIG. 1 is a plan view of a card connector according to an embodiment of this invention;

FIG. 2 is a perspective view of a cover of the card connector illustrated in FIG. 1;

FIG. 3 is a perspective view of the cover illustrated in FIG. 2 together with a card in a state where a compression coil spring is omitted;

FIG. 4 is a perspective view of an ejecting member of the card connector in FIG. 1;

FIG. 5A is a perspective view showing a base and an ejecting mechanism of the card connector in FIG. 1, together with the card which is being inserted;

FIG. 5B is an enlarged view of a characteristic part of the base in the state illustrated in FIG. 5A;

FIG. 5C is an enlarged view of a characteristic part of the cover in the state illustrated in FIG. 5A;

FIG. 6A is a perspective view of the base and ejecting mechanism of the card connector in FIG. 1, together with the card which is completely inserted;

FIG. 6B is an enlarged view of a characteristic part of the base in the state in FIG. 6A;

FIG. 6C is an enlarged view of a characteristic part of the cover in the state in FIG. 6A;

FIG. 7 is a plan view showing a half-assembled state of the card connector, for describing a structure of fixing the cover to the base;

FIG. 8A is a perspective view showing a characteristic part of the cover in another structure of fixing the cover to the base;

FIG. 8B is a front view of a part of FIG. 8A;

FIG. 9 is a perspective view of a characteristic part of the base corresponding to the cover illustrated in FIG. 8A:

FIG. 10 is a perspective view of a characteristic part of the card connector using the cover in FIG. 8A and the base in FIG. 9;

FIG. 11 is a view for describing a state where the card is erroneously inserted; and

FIG. 12 is an enlarged view of a characteristic part of FIG. 11.

### DESCRIPTION OF THE PREFERRED EMBODIMENTS

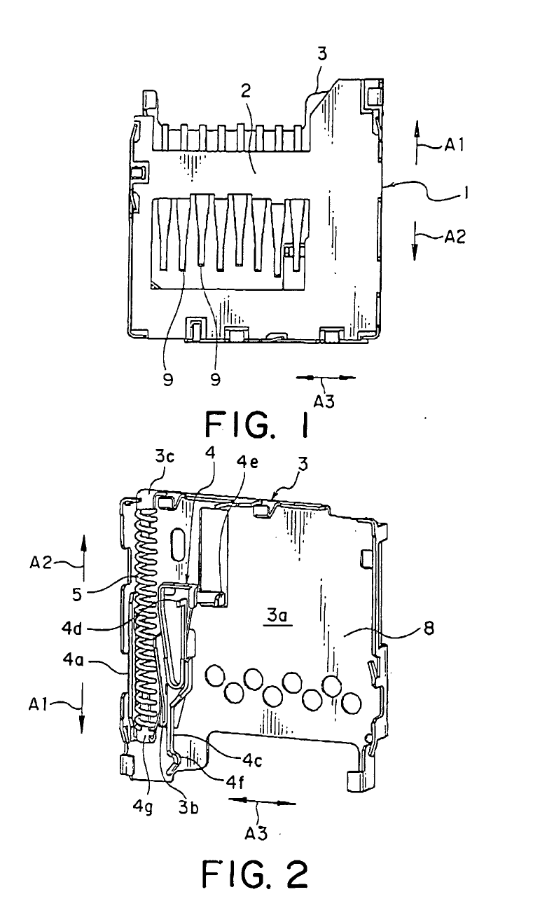

Referring to FIGS. 1 to 3, description will be made of a basic structure of a card connector according to an embodiment of this invention.

The card connector 1 illustrated in FIGS. 1 to 3 is a so-called push-push type card connector and comprises a base 2 made of an insulating material and a metal cover 3. The base 2 and the cover 3 are faced to each other in a direction perpendicular to a drawing sheet. A combination of the base 2 and the cover 3 will be called a connector body.

The card connector 1 further comprises an ejecting member 4 made of metal and movable in a first direction A1, and a compression coil spring 5 urging the ejecting member 4 in an ejecting direction, i.e., the first direction A1. The ejecting member 4 and the compression coil spring 5 are fixed to an inner surface 3a of the cover 3.

A card 7 is inserted between the base 2 and the cover 3 in a second direction A2 opposite to the first direction A1. Specifically, between the base 2 and the cover 3, a space 8 is defined to receive the card 7. The ejecting member 4 and the compression coil spring 5 are disposed adjacent to the space 8 in a widthwise direction, i.e., a third direction A3 perpendicular to the first and the second directions A1 and A2. The inner surface 3a of the cover 3 is provided with a receiving portion 3b , comprising a wall portion faced to the ejecting member 4 in the third direction A3 and extending in the first and the second directions A1 and A2.

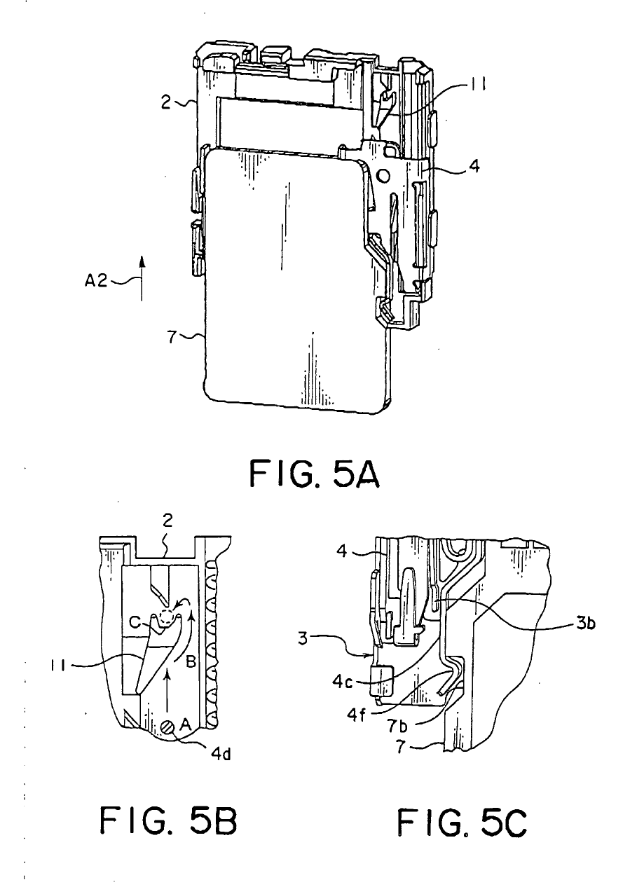

On the other hand, the base 2 holds a plurality of conductive contacts 9 to be contacted with a plurality of signal patterns 7a of the card 7. The contacts 9 are arranged in parallel to one another in the third direction A3. Each of the contacts extends in the first and the second directions A1 and A2. As illustrated in FIG. 5A, the base 2 is provided with a heart cam 11 formed on its inner surface to control movement of the ejecting member 4. A combination of the ejecting member 4 and the heart cam 11 will herein be called an ejecting mechanism. The relationship between the ejecting member 4 and the heart cam 11 will later be described in detail.

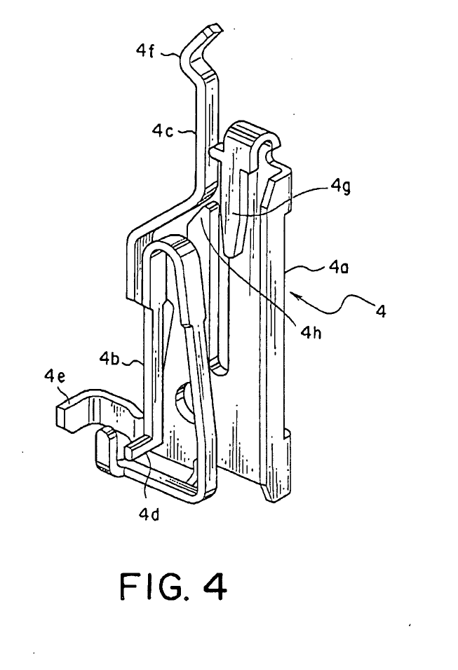

Referring to FIG. 4, the ejecting member 4 will be described.

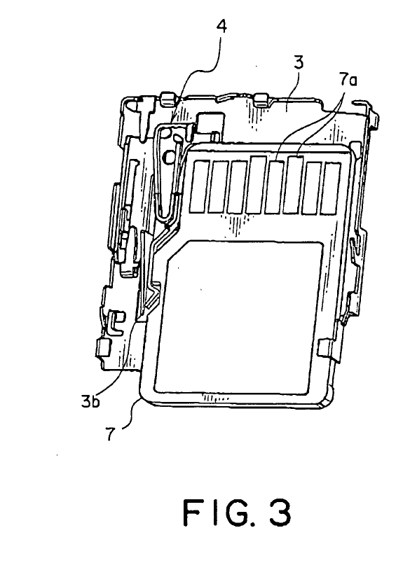

The ejecting member 4 comprises an ejecting member body 4a guided by the cover 3 and movable in the first and the second directions A1 and A2, a cam follower 4b, and an elastically deformable locking member 4c for preventing the card 7 (see FIG. 3 and so on) from unintentionally jumping out from the connector 1. The ejecting member body 4a, the cam follower 4b, and the locking member 4c are integrally coupled to form an integral structure. The cam follower 4b is elastically deformable and has a free end 4d formed at its end to move along the heart cam 11 (see FIG. 5A and so on).

The ejecting member 4 further comprises a contacting portion 4e to be contacted with an end portion of the card 7, an engaging portion, i.e., a locking portion 4f to be engaged with a recess 7a formed on a lateral edge of the card 7, a spring receiving portion 4g for receiving the compression coil spring 5, and a receiving portion 4h for preventing excessive deformation of the locking member 4c. The locking portion 4f is formed at an end of the locking member 4c and, with elastic deformation of the locking member 4c, is displaceable between a first position where it is engaged with the recess 7a and a second position where it is disengaged from the recess 7a.

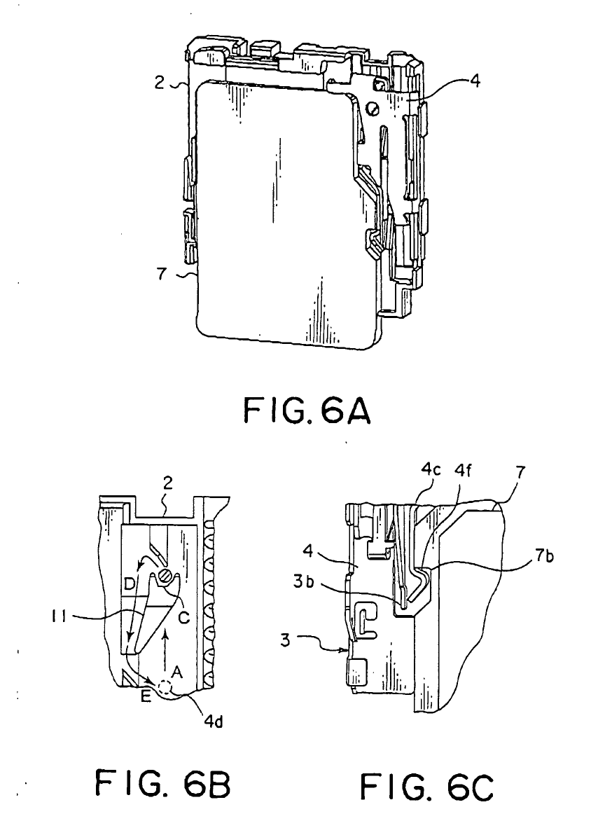

Referring to FIGS. 5A to 5C and 6A to 6C in addition, the card connector 1 will continuously be described.

A part near one end of the compression coil spring 5 is fitted over a protruding portion 3c formed on the cover 3 by bending. A part near the other end of the compression coil spring 5 is fitted over the spring receiving portion 4g of the ejecting member 4. Therefore, the ejecting member 4 is continuously urged by the compression coil spring 5 in the first direction A1 with respect to the connector 1.

The heart cam 11 formed on the base 2 defines a circulating track for the free end 4d of the cam follower 4b. Specifically, the circulating track has a starting point A, a forward stroke guide portion B inclined with respect to the first and the second directions A1 and A2, a recessed portion C, a backward stroke guide portion D inclined with respect to the first and the second directions A1 and A2, and an end point E, i.e., the starting point A.

When the card 7 is inserted as shown in FIG. 5A, the locking portion 4f of the ejecting member 4 is engaged with an engaged portion, i.e., a recessed portion 7b of the card 7 as shown in FIG. 5C. In this state, when the card 7 is pushed by a finger or the like in the second direction A2, the ejecting member 4 moves in the second direction A2 following the card 7, with compression of the compression coil spring 5. As a result, as shown in FIG. 5B, the free end 4d of the ejecting member 4 moves from the starting point A, passes along the forward stroke guide portion B, and reaches a position depicted by a dashed-line circle in the recessed portion C.

Thereafter, when the finger or the like is released from the card 7, the free end 4d of the ejecting member 4 is engaged with the recessed portion C of the heart cam 11 by a restoring force of the compression coil spring 5. As a consequence, the ejecting member 4 is locked.

Further, the locking member 4c and the locking portion 4f of the ejecting member 4 reach a position faced to the receiving portion 3b in the third direction A3 as shown in FIG. 6C. Therefore, the locking member 4c is prevented from elastic deformation. Accordingly, the locking portion 4f and the recessed portion 7a of the card 7 are not disengaged from each other so that the card 7 is locked also. In this state, the signal patterns 7a of the card 7 are contacted with the contacts 9 so that the card 7 is electrically connected to the connector 1.

When the card 7 is again pushed in the second direction A2 by the finger or the like, the free end 4d of the ejecting member 4 is released from the recessed portion C. Therefore, by the restoring force of the compression coil spring 5, the free end 4d of the ejecting member 4 passes along the backward stroke guide portion D and returns to a position depicted by a dashed-line circle at the end point E, i.e., at the starting point A. Consequently, the card 7 moves in the first direction A1 also. At this time, the locking portion 4f is engaged with the recessed portion 7a of the card 7 so that the card 7 is prevented from being unintentionally jumped out from the connector 1.

As a result of movement of the card 7 in the first direction A1, the locking portion 4f of the ejecting member 4 is apart from the receiving portion 3b as illustrated in FIG. 5C. Therefore, by pulling the card 7 in the first direction A1, engagement between the locking portion 4f and the recessed portion 7a of the card 7 is easily released so that the card 7 is allowed to be pulled out from the connector 1.

In the foregoing, the receiving portion 3b is formed on the cover 3. However, the receiving portion 3b may be formed at any appropriate position of the base 2.

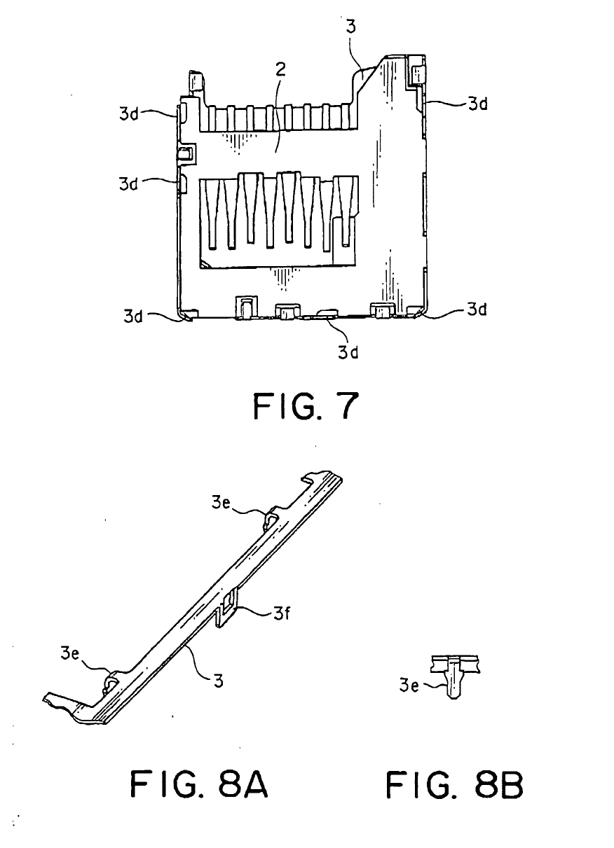

Referring to FIG. 7, description will be made of a structure of fixing the cover 3 to the base 2.

As illustrated in FIG. 7, the cover 3 is fitted to the base 2. Thereafter, six bending legs 3d are bent to fix the cover 3 to the base 2.

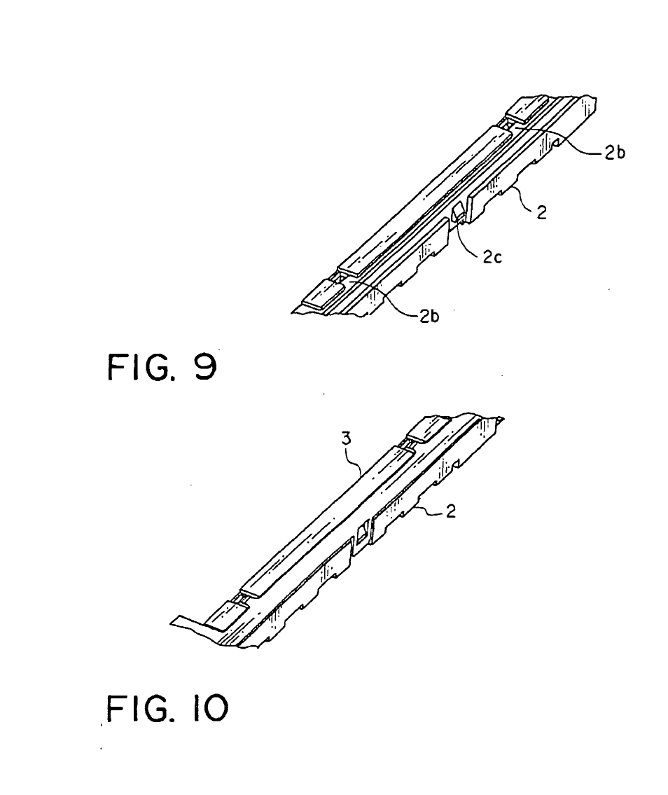

Referring to FIGS. 8 to 10, description will be made of another structure of fixing the cover 3 to the base 2.

As shown in FIGS. 8A and 8B, the cover 3 has protruding portions 3e formed at two inner positions on each of left and right side portions thereof and a protruding portion 3f formed at one outer position of each of the left and the right side portions thereof. On the other hand, as illustrated in FIG. 9, the base 2 has recessed portions 2b formed at two inner positions on each of left and right side portions thereof and a raised portion 2c formed at one outer position of each of left and right side portions thereof. The protruding portions 3e are press-fitted into the recessed portions 2b. The protruding portion 3f is latched to the raised portion 2c. As a result, the state illustrated in FIG. 10 is reached.

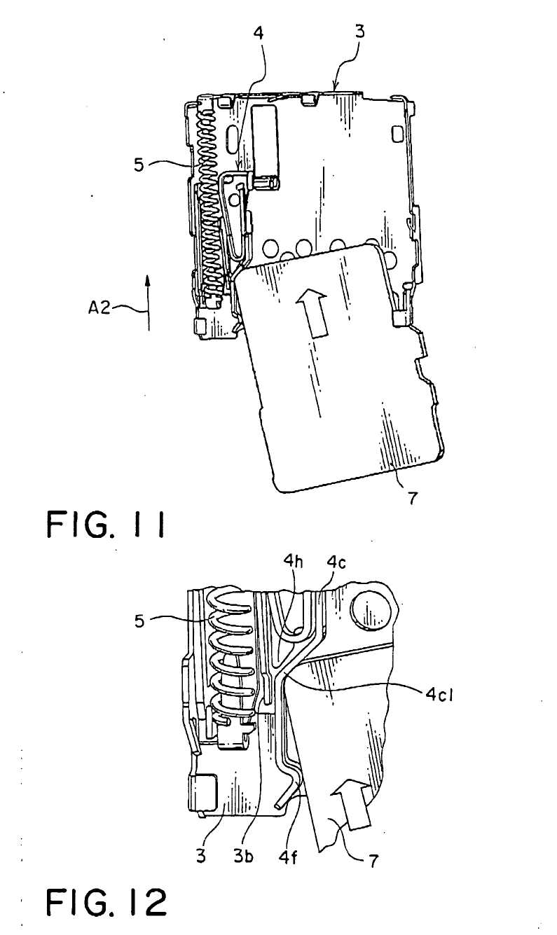

Referring to FIGS. 11 and 12, description will be made of the case where the card 7 is improperly or erroneously inserted into the connector 1 in a position inclined with respect to the second direction A2. Herein, erroneous insertion collectively includes insertion of the card 7 into the connector 1 in an inclined position, insertion in an upside-down position, and insertion in a frontward-back position.

In FIGS. 11 and 12, a front left corner of the card 7 is contacted with a bent portion 4c1 of the locking member 4c. When the bent portion 4c1 is pushed by the card 7, a part around the bent portion 4c1 is brought into contact with the receiving portions 3b and 4h. Therefore, the locking member 4c is prevented from further elastic deformation so that the card 7 is prevented from being erroneously inserted into the connector 1.

While the present invention has thus far been described in connection with the preferred embodiment thereof, it will readily be possible for those skilled in the art to put this invention into practice in various other manners.

What is claimed is:

1. A card connector for connecting a card, the card connector comprising:
a connector body for receiving the card; and
an ejecting mechanism coupled to the connector body and adapted to eject the card;
the ejecting mechanism comprising:
an ejecting member to be moved together with the card; and
a cam coupled to the connector body for controlling movement of the ejecting member;
the ejecting member comprising:
an ejecting member body guided by the connector body;
a cam follower connected to the ejecting member body and guided by the cam; and
a locking portion connected to the ejecting member body and displaceable between a first position where movement of the card is locked and a second position where movement of the card is unlocked;
the connector body having a receiving portion for maintaining the locking portion at the first position where the ejecting member is located at a specific position.

2. The card connector according to claim 1, wherein the specific position corresponds to a position where the card is connected to the connector.

3. The card connector according to claim 2, wherein the ejecting member has a spring portion elastically supporting the locking portion to the ejecting member body, the spring portion urging the locking portion towards the first position.

4. The card connector according to claim 1, wherein the connector body includes a cover coupled to the ejecting member, the receiving potion being formed on the cover.

5. The card connector according to claim 4, wherein each of the ejecting member and the cover is made of metal.

6. The card connector according to claim 1, wherein the connector body includes a base and a cover faced to each other to define a space formed therebetween to receive the card, the ejecting mechanism being disposed between the base and the cover to be adjacent to the space.

7. The card connector according to claim 1, wherein the base is made of an insulating material, each of the ejecting member and the cover being made of metal.

8. The card connector according to claim 7, wherein the ejecting member is formed on the cover and the cam is formed on the base.

9. The card connector according to claim 1, wherein the locking member and the receiving portion are contacted with each other when the card is inserted, thereby preventing erroneous insertion of the card.

10. The card connector according to claim 1, wherein the ejecting portion has a second receiving portion, the locking member and the second receiving portion being brought into contact with each other when the card is inserted, thereby preventing erroneous insertion of the card.
